(19) United States
(12) Patent Application Publication
(10) Pub. No.: US 2015/0242887 A1
(43) Pub. Date: Aug. 27, 2015

(54) METHOD AND SYSTEM FOR GENERATING A TARGETED CHURN REDUCTION CAMPAIGN

(71) Applicant: Linkedln Corporation, Mountain View, CA (US)

(72) Inventors: Deepak Agarwal, Sunnyvale, CA (US); Kun Liu, Sunnyvale, CA (US); Bo Long, Palo Alto, CA (US); Anmol Bhasin, Los Altos, CA (US)

(73) Assignee: Linkedln Corporation, Mountain View, CA (US)

(21) Appl. No.: 14/191,260

(22) Filed: Feb. 26, 2014

(51) Int. Cl. G06Q 30/02; G06Q 50/00

(52) U.S. Cl. CPC G06Q 30/0251; G06Q 50/01

(57) ABSTRACT

A system to generate a targeted churn reduction campaign in an on-line social networking system may be implemented as a churn reduction campaign generator. In one embodiment, a churn reduction campaign generator utilizes a subscriber retention model and a churn probability model. When there is an indication, within an on-line social networking system, that a member, who is a subscriber to a paid service in the on-line social networking system, is likely to fail to renew their subscription (or “churn”), the churn reduction campaign generator executes the subscriber retention model to trigger a targeted subscriber retention campaign.

### TECHNICAL FIELD

This application relates to the technical fields of software and/or hardware technology and, in one example embodiment, to the system and method to generate a targeted churn reduction campaign in an on-line social networking system.

### BACKGROUND

Churn rate measures a number of individuals that leave a group or other collection over a certain period of time, such as a number of subscribers that leave a subscription-based service. Churn, therefore, is similar to attrition, and may be the opposite of retention. For example, a subscriber-based service model may succeed when subscriber churn is low (and retention is high), and may fail when subscriber churn is high (and retention is low), among other things.

Industries that rely on subscription-based service models, such as the cable television industry, the cell phone industry, web-based services, and so on, spend a considerable amount of time, money, and effort attempting to identify reasons why their subscribers churn, in order to provide retention incentives to subscribers that keep them from ending use of provided services. However, their efforts often lack insight or are driven by information received directly from subscribers or from simple metrics, which may lead to ineffective results and unsuccessful determinations as to why subscribers are not being retained, among other problems.

A service provider may run an on-line promotional campaign, where current subscribers are offered a discount on one or more services in hopes that it would incentivise the subscribers to renew their subscriptions.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate a targeted churn reduction campaign in an on-line social networking system may be implemented;

FIG. 2 is block diagram of a system to generate a targeted churn reduction campaign in an on-line social networking system, in accordance with one example embodiment;

FIG. 3 is a flow chart of a method performed at a server system to generate a targeted churn reduction campaign in an on-line social networking system, in accordance with an example embodiment;

FIG. 4 illustrates a user interface (UI) screen depicting a recommendation provided to a member via a home page of the member, in accordance with an example embodiment;

FIG. 5 illustrates a UI screen depicting a recommendation provided to a member via a via a banner ad, in accordance with an example embodiment;

FIG. 6 illustrates a UI screen depicting a recommendation provided to a member via a news feed page of the member, in accordance with an example embodiment; and

FIG. 7 is a diagrammatic representation of an example machine in the form of a computer system within which a set of instructions, for causing the machine to perform any one or more of the methodologies discussed herein, may be executed.

### DETAILED DESCRIPTION

A method and system to generate a targeted churn reduction campaign in an on-line social networking system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

An on-line social network may be viewed as a platform to connect people in virtual space. An on-line social network may be a web-based platform, such as, e.g., a social networking web site, and may be accessed by a user via a web browser. An on-line social network may be a business-focused social network that is designed specifically for the business community, where registered members establish and document networks of people they know and trust professionally. Each registered member may be represented by a member profile. A member profile may be represented by one or more web pages. A member profile is used to store information associated with the member, such as, e.g., personal information, professional information, member's likes and preferences, etc. A member's profile web page of a social networking web site may emphasize employment history and education of the associated member. For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

A system to generate a targeted churn reduction campaign in an on-line social networking system may be implemented as a churn reduction campaign generator. In one embodiment, a churn reduction campaign generator utilizes a so-called subscriber retention model and a so-called churn probability model which are described further below. In operation, when there is an indication, within an on-line social networking system, that a member, who is a subscriber to a paid service in the on-line social networking system, is likely to fail to renew their subscription (or “churn”), the churn reduction campaign generator executes the subscriber retention model to trigger a targeted subscriber retention campaign. The probability of a member failing to renew their subscription may be termed a churn probability for the member.

The churn probability for a member is determined by executing a churn probability model. The churn probability model may determine a churn probability for a given subscriber in a variety of ways. For example, the churn probability model may be configured to receive, as input, information associated with a subscriber, and output a churn probability that the subscriber will churn and end the subscription (or, on the other hand, output a retention probability that the subscriber will retain the subscription). Example input that may be utilized by the churn meter when determining a probability may include profile information for the subscriber (e.g., job title, seniority, years at title, and so on), activity information (e.g., the frequency and/or intensity of performed activities), time period information (e.g., when activities were performed), and so on.

A churn probability model may apply certain formulas and/or algorithms to the input information in order to determine a churn probability for a certain subscriber at a certain point of time within a subscription period. For example, the churn probability model may assign an importance or weight to certain features representing activities based on various scoring formulas, such as the Fisher Score method, the Pearson Coefficient method, and other analytical methods. The churn probability model may then calculate probabilities based on the scores, such as by using Relative Time Derivative methods, among other techniques.

The output of a churn probability model may have a value between 0 and 1. A churn probability model may determine and/or calculate a churn probability for an individual subscriber by performing a simple vector product of each input variable (e.g. variables composed of raw and/or synthesized subscriber data from social networking services), with unique weights associated with each input variable. In one embodiment, the churn probability may be represented using equation (1) shown below

p(churn)=Σ_{c}xyᵢ (1),

where x is a vector array of input variables (from 0 to i), and y is a vector array of corresponding weights associated with each variable in vector x.

For example, the churn probability model may provide input for a subscriber that indicates the subscriber has (1) performed very few searches within the last 30 days of their subscription, (2) sent no direct messages within the past 60 days, and (3) has a job title that is associated with a senior level position. The churn probability model may receive such inputs and output a high churn probability (e.g., P(churn)=50% or higher). In some embodiments, the churn probability p, for a member i may be determined by executing a logistic regression model, which is described further below.

The churn probability model may be executed for each member of the on-line social networking system. It may be executed with a certain periodicity, automatically or on demand. If the result of executing the churn probability model indicates that the churn probability for a particular member is above a certain predetermined threshold value (e.g., the churn probability for the member is greater than 50%), the system to generate a targeted churn reduction campaign in an on-line social networking system triggers a targeted subscriber retention campaign for that particular member. It will be noted, that in some embodiments, the targeted subscriber retention campaign for a particular member is not triggered when the churn probability for that member is particularly high, as it may be inferred that the member, for whom the churn probability is higher that a certain threshold (e.g., if the churn probability for a member is greater than 90%), it is unlikely that a churn reduction campaign would be successful if applied to that member.

A targeted subscriber retention campaign may be commenced by executing a so-called subscriber retention model. Generally speaking, a subscriber retention model evaluates behavior of the member in the on-line social networking system and determines the changes in the member's behavior that would potentially affect the churn probability for that member. A member's behavior in the on-line social networking system is represented by values assigned to features. Features may represent activities such as searching, sending emails, viewing other members' profiles, etc. A value assigned to a feature indicates how actively the member engages in the associated activity. For example, a value assigned to a feature may indicate intensity and/or frequency, with which the feature is utilized by the member.

Frequency value for a particular feature is calculated by increasing the frequency value by a certain increment if the associated activity was performed during a certain base time period, regardless of how many times the activity has been performed during that base time period. Intensity is calculated by increasing the intensity value each time the activity was performed. Thus, if a base time period is one day, and a member performed a search activity once a day for seven days and ten times during the eighth day, the frequency value for that activity over the eight day period is eight, while the intensity value is seventeen. In some embodiments an combined value may be generated based on both the intensity and the frequency values. The value assigned to a feature may be weighted based on the perceived importance of the activity associated with the feature.

A subscriber retention model is executed with respect to a specific member of the on-line networking system. It may be configured to operate as follows. First, a desired churn probability for the member is selected. A desired churn probability may be a value that is lower than the threshold churn probability value that triggers the execution of the subscriber retention model. Given the desired churn probability for the member, the subscriber retention model determines, for each feature, a target value of the feature indicating how the value of that feature would have to be changed in order to bring the churn probability down to the desired value. Next, for each feature, the subscriber retention model calculates the cost of the change of the value of each feature to its target value. The feature that was determined to have the lowest cost of the change of the value to its target value is selected as a target feature. The churn reduction campaign generator then generates or selects a recommendation and provides the recommendation to the member. Some example recommendations in the form of motivational messages are shown below.
“Hi there, do you know with your premium plan you can still send 30 direct messages to anyone on LinkedIn? Response guaranteed!”
“You may want to try out the premium search that comes with your plan and get up to 8 advanced search filters”
“Hi, with your premium plan, you can see the full list of people interested in your profile. Try ‘who viewed my profile’ now!”
“Hi there, a complete profile makes you stand out of other job applicants. Get your profile updated today!”
“Hi, you current plan allows you to view full profiles of everyone in your network up to 2nd degree. Try it now!”
“LinkedIn has over 3 million companies pages. Follow the company you like and get most up-to-date information!”

Such recommendations may be delivered to the member via an email, or they may be posted on one of the web pages of the on-line networking system on the member's home page, as a banner ad, on the member's news feed page, etc.

In mathematical terms, a churn probability model may be referred to as a logistic regression model, and a subscriber retention model may be referred to as a logistic perturbation model. An algorithm utilizing a logistic regression model and a logistic perturbation model is shown below.

1. Learn logistic regression model:

$${min}_{w} {\sum }_{i = 1}^{n} ( {y}_{i} log ( \begin{matrix}1 + exp ( - {w}^{T} ( {x}_{i}^{i - 1} , {x}_{i}^{t} ) ) - \\ ( 1 - {y}_{i} ) log\end{matrix} ( \frac{exp ( - {w}^{T} ( {x}_{i}^{t - 1} , {x}_{i}^{t} )}{1 - exp ( - {w}^{T} ( {x}_{i}^{t - 1} , {x}_{i}^{t} )} ) )$$

where (xᵢ^{t-1},xᵢ^{t}) denotes a feature vector concatenating (xᵢ^{t-1} and xᵢ^{t}); w denotes the model parameter to learn; n denotes the number of users.

2. Learn logistic perturbation model:
2.1 Solve

$$\begin{matrix}f ( {x}_{ij}^{i + 1} ) = \frac{1}{1 + exp ( - {w}^{{T}_{i}} ( {x}_{i}^{t} , {x}_{i}^{t + 1} )} \\ = {p}^{*}\end{matrix}$$

to obtain xᵢⱼ^{t+1}, the value that the activity feature j is expected to be at, future time t+1 in order to reduce the churn probability to p*;
2.2 Calculate the cost for user i from xᵢⱼ^{t} to xᵢⱼ^{t+1}, c(xᵢⱼ^{t},xᵢⱼ^{t+1});
2.3 Sort c(xᵢⱼ^{t},xᵢⱼ^{t+1}) for each user i to obtain the optimal activity feature with minimum cost.
xᵢ^{t} denotes activity features vector (such as profile editing frequency and page view frequency features) for use i at time t;
xᵢⱼ^{t} denotes jth feature in xᵢ^{t};
yᵢ^{t} denotes churn label (either 0 or 1 for not churn or churn) for use i at time t;
c(:) denotes a cost function;

The model parameter to learn in the logistic regression model—“w”—is the weighted value assigned to each feature for each member. The model parameter to learn in the logistic perturbation model—“c( . . . )”—is the cost of the change of the value of the j^{th} feature to its target value for the i^{th} member.

This algorithm can be generalized to situations beyond logistic regression model by replaying logistic loss function by other loss functions.

A system to generate a targeted churn reduction campaign in an on-line social networking system may also be configured to evaluate performance of a targeted churn reduction campaign by comparing the outcome of the campaign (whether the member churned or not within a certain period of time subsequent to the commencement of the churn reduction campaign) to the predicted outcome and also by examining the member's actions in response to the presentation of a recommendation generated as part of the targeted churn reduction campaign. For example, a churn reduction campaign generator may include a campaign outcome monitor configured to detect that a recommendation has been delivered to a member, and commence monitoring activities of the member to determine whether the member engaged into the recommended activity. The campaign outcome monitor may also be configured to detect whether the member renewed their subscription or subscribed to another paid service provided by the on-line networking system subsequent to the delivery of the recommendation.

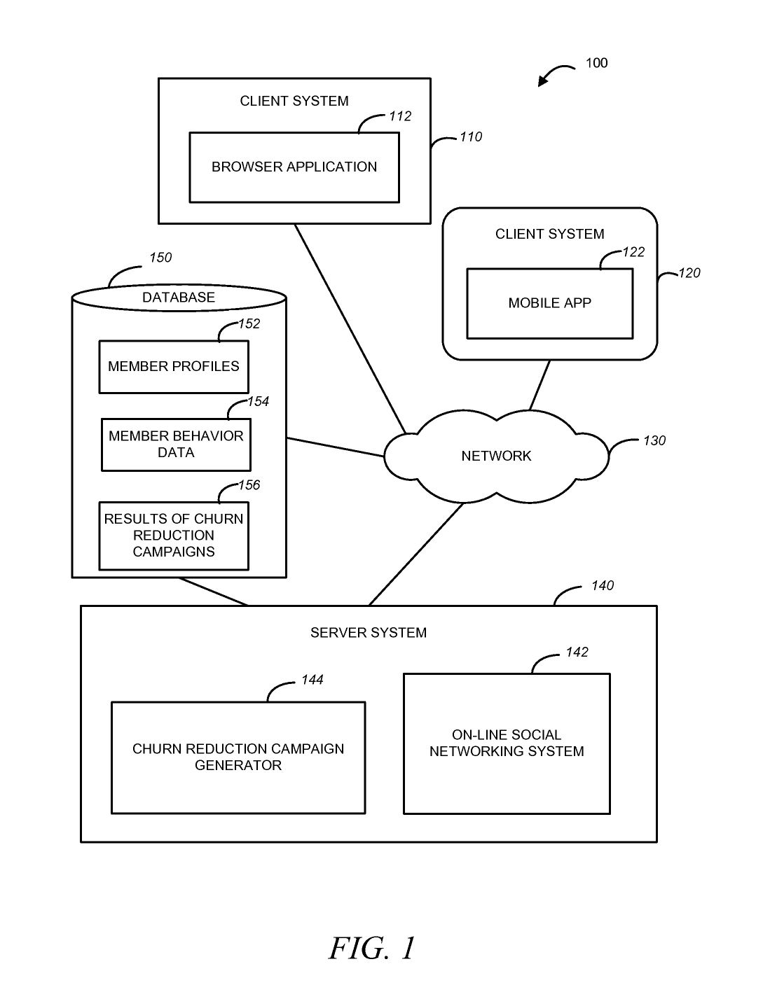

An example method and system to generate a targeted churn reduction campaign in an on-line social networking system may be implemented in the context of a network environment 100 illustrated in FIG. 1. As shown in FIG. 1, the network environment 100 may include client systems 110 and 120 and a server system 140. The server system 140, in one example embodiment, may host an on-line social networking system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client system 110 may execute a browser application 112 that could be used to access the on-line social networking system 142 provided at the server system 140. The client system 120 may be a mobile device and may execute a mobile app 122 that could be used to access the on-line social networking system 142. The client systems 110 and 120 may access to the server system 140 via a communications network 130. The communications network 130 may be a public network (e.g., the Internet, a mobile communication network, or any other network capable of communicating digital data).

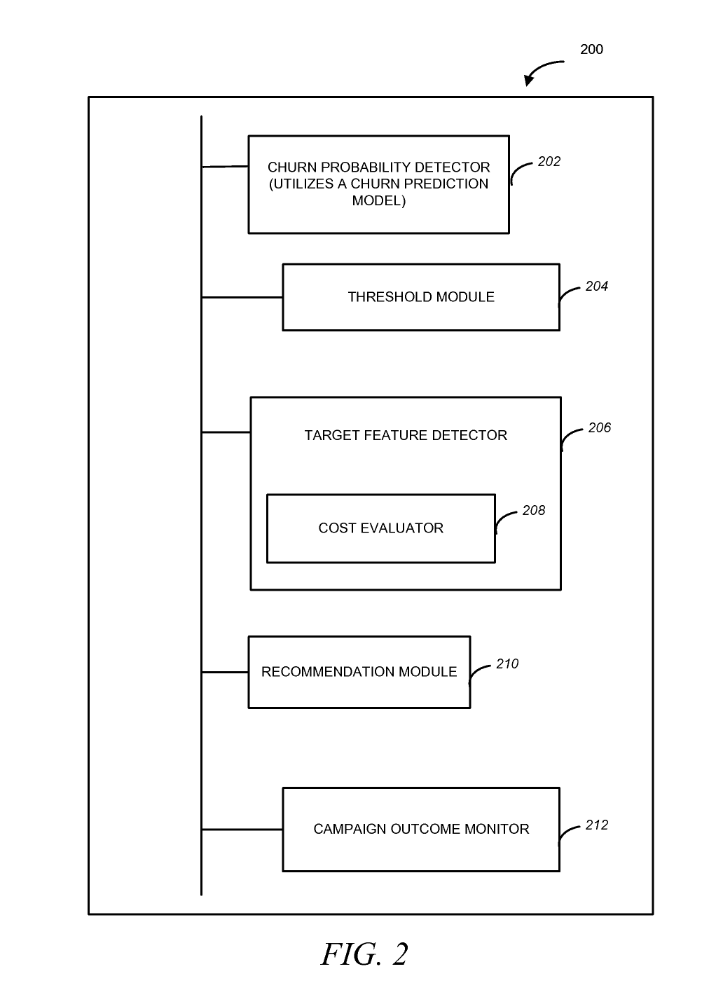

As shown in FIG. 1, the server system 140 also hosts a churn reduction campaign generator 144, which, in some embodiments, may be part of the on-line social networking system 142. As described above, the churn reduction campaign generator 144, in one example embodiment, utilizes a subscriber retention model and a churn probability model. When the churn reduction campaign generator 144 detects an indication, within the on-line social networking system 142, that a member, who is a subscriber to a paid service in the on-line social networking system, is likely to churn or fail to renew their subscription), the churn reduction campaign generator 144 executes the subscriber retention model to trigger a targeted subscriber retention campaign. The churn reduction campaign generator 144 utilizes member behavior data 154 to determine churn probability for each member of the on-line social networking service 142. The churn reduction campaign generator 144 may be configured to utilize results of churn reduction campaigns 156 to evaluate whether a particular targeted churn reduction campaign was successful. The member behavior data 154 and the results of churn reduction campaigns 156 may be stored in the database 150. An example churn reduction campaign generator 144 is illustrated in FIG. 2.

FIG. 2 is a block diagram of a system 200 to generate a targeted churn reduction campaign in an on-line social networking system, in accordance with one example embodiment. As shown in FIG. 2, the system 200 includes a churn probability detector 202, a threshold module 204, a target feature detector 206, a cost evaluator 208, and a recommendation module 208. The churn probability detector 202 may be configured to determine churn probability for a member based on utilization, by the member, of one or more features provided by the on-line social networking system 142 of FIG. 1. The member may be a subscriber to a service provided by the on-line social networking system 142. The churn probability indicates probability of the member failing to renew a subscription to the service. The churn probability detector 202 utilizes a churn probability model described above. The churn probability detector 202 takes, as input, values assigned to features that represent actual and potential activities of the member in the on-line social networking system 142. A value assigned to a feature indicates how actively the member engages in the associated activity, e.g., the intensity and/or frequency of the feature utilization. For example, a value assigned to a feature may represent one of the following parameters:
frequency and/or intensity of ‘inmails’ (messages to specific members of the on-line social networking system 142) sent by a member during certain time period;
frequency and/or intensity of people searches performed by a member during certain time period;
frequency and/or intensity of job searches performed by a member during certain time period;
frequency and/or intensity of company searches performed by a member during certain time period;
frequency and/or intensity of ‘who viewed my profile’ page views performed by a member during certain time period;
frequency and/or intensity of viewing other members' profiles performed by a member during certain time period;
frequency and/or intensity of profile editing performed by a member during certain time period;
frequency and/or intensity of company page views performed by a member during certain time period;
frequency and/or intensity of ‘people you may know’ page views during certain time period; and
frequency and/or intensity of mobile page views performed by a member during certain time period.

The threshold module 204 may be configured to compare the churn probability to a threshold value to determine whether the churn probability for a member is greater than the threshold value. If the result of comparing indicates that the churn probability for a particular member is above a certain predetermined threshold value that (e.g., the churn probability for the member is greater than 50%), a targeted subscriber retention campaign is triggered for that particular member. As mentioned above, in some embodiments, the a targeted subscriber retention campaign for a particular member is not triggered when the churn probability for that member is particularly high, as it may be inferred that the member, for whom the churn probability is higher that a certain threshold (e.g., if the churn probability for a member is greater than 90%), it is unlikely that a churn reduction campaign would be successful if applied to that member.

The target feature detector 206 may be configured to determine that an increase in utilization by the member of a particular feature would result in decreasing the churn probability for the member to a desired lower probability, based on applying the logistic perturbation model described above. The target feature detector 206 may include a cost evaluator 208. The cost evaluator 208 may be configured to determine, for each feature, the cost of the increase in its utilization by the member that would decrease the churn probability for the member to a desired lower probability and select the feature (termed the target feature), for which the cost is the lowest.

The recommendation module 210 may be configured to provide the member with a recommendation with respect to the target feature determined by the target feature detector 206 and its cost evaluator 208. Such recommendation may be provided to the member via a news feed of the member in the on-line networking system 142, via a banner ad in the on-line networking system 142, via a home page of the member in the on-line networking system 142, etc. The recommendation module 210 may also be configured to provide such recommendations via an e-mail message to the member.

Also shown in FIG. 2 is a campaign outcome monitor 212. The campaign outcome monitor 212 may be configured to determine whether the member, to whom a churn reduction campaign was directed, renewed their subscription to the service subsequent to the campaign (subsequent to the recommendation with respect to the target feature). The campaign outcome monitor 212 may also be configured to store a result of the determining in a storage system associated with the on-line social networking system 142, e.g., in the database 150 of FIG. 1.

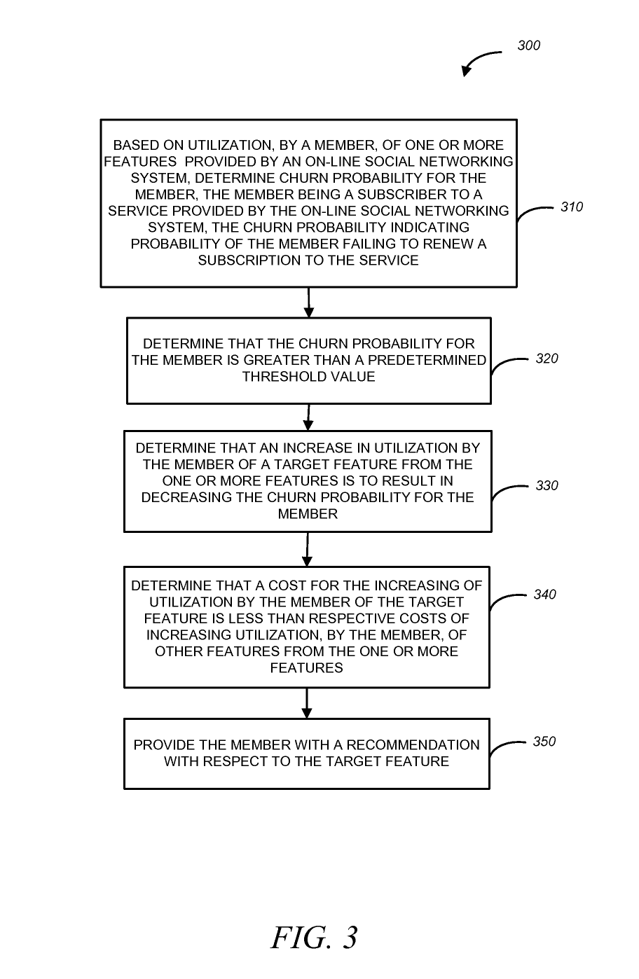

Example operations performed by the system 200 to generate a targeted churn reduction campaign in an on-line social networking system may be described with reference to FIG. 3.

FIG. 3 is a flow chart of a method 300 performed at a server system to generate a targeted churn reduction campaign in an on-line social networking system, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the churn probability detector 202 of FIG. 2 determines churn probability for a member based on utilization, by the member, of one or more features provided by the on-line social networking system 142 of FIG. 1. At operation 320, the threshold module 204 of FIG. 2 determines that the churn probability for the member is greater than a threshold value. At operation 330, the target feature detector of FIG. 2 determines that an increase in utilization by the member of a particular feature (a target feature) would result in decreasing the churn probability for the member to a desired lower probability, based on applying the logistic perturbation model described above. At operation 340, the cost evaluator 208 of FIG. 2 determines that a cost of the increase in utilization by the member of the target feature is less than respective costs of increasing utilization, by the member, of other features from the one or more features provided by the on-line social networking system 142. At operation 350, the recommendation module 210 provides the member with a recommendation with respect to the target feature determined by the target feature detector 206 and its cost evaluator 208.

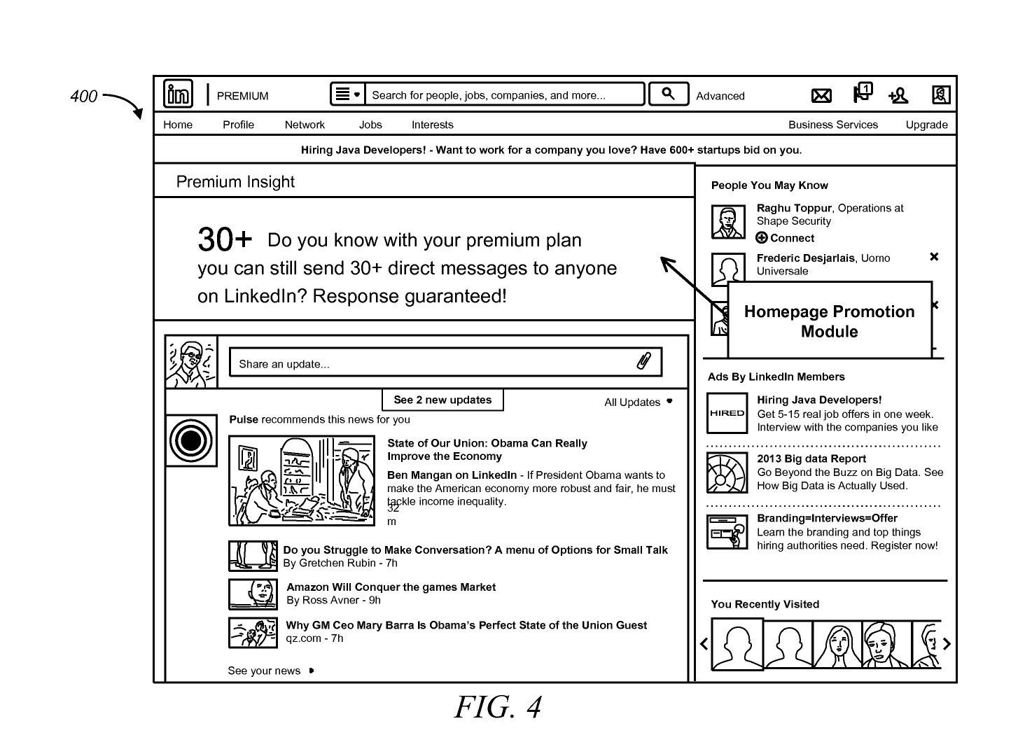

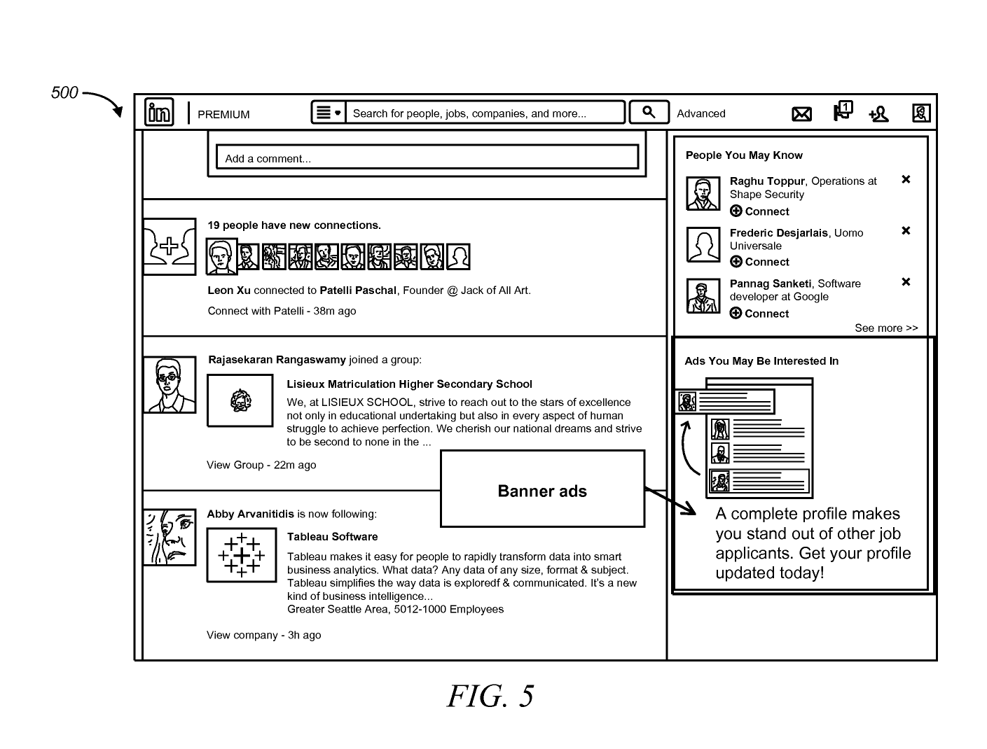

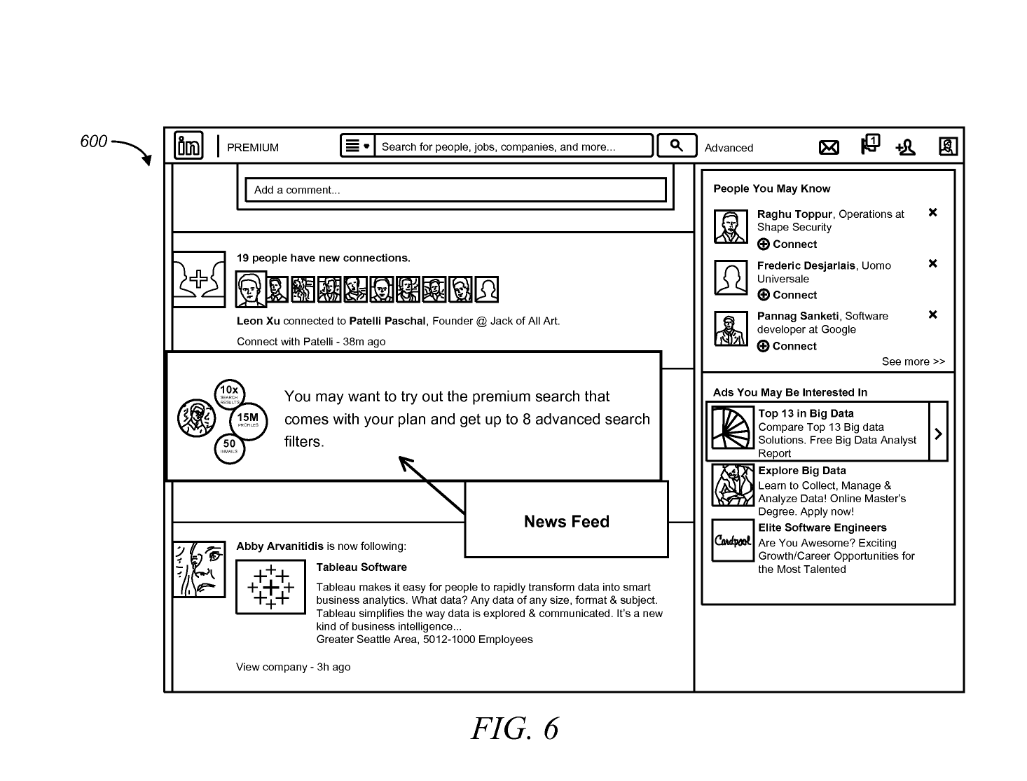

As mentioned above, recommendations may be provided to the member via a news feed of the member in the on-line networking system 142, via a banner ad in the on-line networking system 142, via a home page of the member in the on-line networking system 142, etc. FIG. 4 illustrates a UI screen 400 depicting a recommendation provided to a member via a home page of the member. FIG. 5 illustrates a UI screen 500 depicting a recommendation provided to a member via a via a banner ad. FIG. 6 illustrates a UI screen 600 depicting a recommendation provided to a member via a home page of the member.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

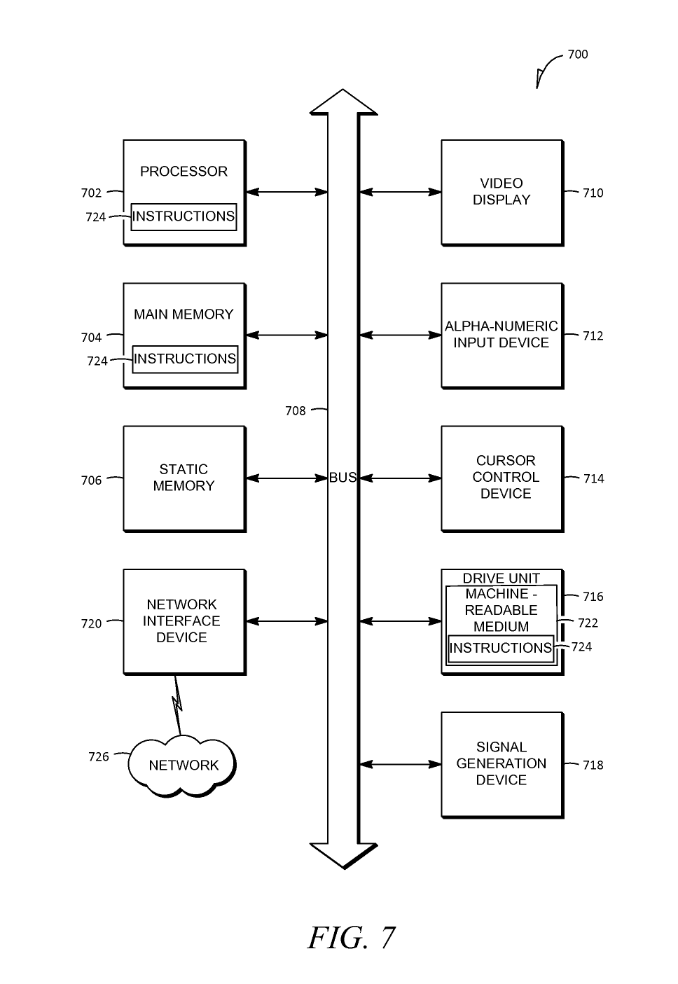

FIG. 7 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to generate a targeted churn reduction campaign in an on-line social networking system has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A computer-implemented method comprising:
based on utilization, by a member, of one or more features provided by an on-line social networking system, determining churn probability for the member, the member being a subscriber to a service provided by the on-line social networking system, the churn probability indicating probability of the member failing to renew a subscription to the service;
determining that the churn probability for the member is greater than a low threshold value;
determining, using at least one processor, that an increase in utilization by the member of a target feature from the one or more features is to result in decreasing the churn probability for the member; and
provide the member with a recommendation with respect to the target feature.

2. The method of claim 1, comprising determining that a cost of the increase in utilization by the member of the target feature is less than respective costs of increasing utilization, by the member, of other features from the one or more features.

3. The method of claim 1, wherein the determining of the churn probability for the member comprises utilizing behavior information of the member, the behavior information monitored and stored in the on-line social networking system.

4. The method of claim 1, wherein the determining of the churn probability for the member comprises determining respective values assigned to the one or more features, a value assigned to a feature from the one or more features indicative of a frequency of utilization of the feature by the member.

5. The method of claim 1, wherein the determining of the churn probability for the member comprises determining respective values assigned to the one or more features, a value assigned to a feature from the one or more features indicative of an intensity of utilization of the feature by the member.

6. The method of claim 1, comprising determining that the churn probability for the member is less than a high threshold value.

7. The method of claim 1, wherein the providing of the recommendation to the member is via a news feed of the member in the on-line networking system, via a banner ad in the on-line networking system, or via a home page of the member in the on-line networking system.

8. The method of claim 1, wherein the providing of the recommendation to the member is via an e-mail message to the member.

9. The method of claim 1, comprising determining whether the member renewed the subscription to the service subsequent to the recommendation with respect to the target feature and storing a result of the determining in a storage system associated with the on-line social networking system.

10. The method of claim 1, comprising monitoring activities of the member in the on-line networking system subsequent to the recommendation with respect to the target feature.

11. A computer-implemented system comprising:
at least one processor coupled to a memory;
a churn probability detector to determine, using the at least one processor, churn probability for a member based on utilization, by the member, of one or more features provided by an on-line social networking system, the member being a subscriber to a service provided by the on-line social networking system, the churn probability indicating probability of the member failing to renew a subscription to the service;
a threshold module to determine, using the at least one processor, that the churn probability for the member is greater than a low threshold value;
a target feature detector to determine, using the at least one processor, that an increase in utilization by the member of a target feature from the one or more features is to result in decreasing the churn probability for the member; and
a recommendation module to provide the member with a recommendation with respect to the target feature, using the at least one processor.

12. The system of claim 11, comprising a cost evaluator to determine that a cost of the increase in utilization by the member of the target feature is less than respective costs of increasing utilization, by the member, of other features from the one or more features.

13. The system of claim 11, wherein the churn probability detector is to determine the churn probability for the member utilizing behavior information of the member, the behavior information monitored and stored in the on-line social networking system.

14. The system of claim 1, wherein the churn probability detector is to determine respective values assigned to the one or more features, a value assigned to a feature from the one or more features indicative of a frequency of utilization of the feature by the member.

15. The system of claim 1, wherein the churn probability detector is to determine respective values assigned to the one or more features, a value assigned to a feature from the one or more features indicative of an intensity of utilization of the feature by the member.

16. The system of claim 1, wherein the threshold module is to determine that the churn probability for the member is less than a high threshold value.

17. The system of claim 1, wherein the recommendation module is to provide the recommendation to the member via a news feed of the member in the on-line networking system, via a banner ad in the on-line networking system, or via a home page of the member in the on-line networking system.

18. The system of claim 1, wherein the recommendation module is to provide the recommendation to the member via an e-mail message to the member.

19. The system of claim 1, comprising a campaign outcome monitor to determine whether the member renewed the subscription to the service subsequent to the recommendation with respect to the target feature and storing a result of the determining in a storage system associated with the on-line social networking system.

20. A machine-readable non-transitory storage medium having instruction data to cause a machine to:
determine churn probability for a member based on utilization, by the member, of one or more features provided by an on-line social networking system, the member being a subscriber to a service provided by the on-line social networking system, the churn probability indicating probability of the member failing to renew a subscription to the service;
determine that the churn probability for the member is greater than a low threshold value;
determine that an increase in utilization by the member of a target feature from the one or more features is to result in decreasing the churn probability for the member; and
provide the member with a recommendation with respect to the target feature.
